(19) United States
(12) Patent Application Publication
(10) Pub. No.: US 2014/0214556 A1
(43) Pub. Date: Jul. 31, 2014

(54) DIRECTORY DELIVERY AND MANAGEMENT SYSTEM

(71) Applicant: TDS MEDIA DIRECT, INC., Cirlce Pines, MN (US)

(72) Inventors: DANIEL ERNEST WILLETT, Deerwood, MN (US); BENJAMIN LEE WILLETT, Lino Lakes, MN (US); JOSHUA DANIEL WILLETT, Lino Lakes, MN (US)

(73) Assignee: TDS MEDIA DIRECT, INC., Circle Pines, MN (US)

(21) Appl. No.: 13/750,800

(22) Filed: Jan. 25, 2013

(51) Int. Cl. G06Q 50/12; G06Q 10/10

(52) U.S. Cl. CPC G06Q 50/12; G06Q 10/10
USPC 705/14.73

(57) ABSTRACT

Systems and methods for delivery of directory services are provided. One method includes receiving an image of an identification code associated with a directory-providing organization, the identification code issued by the directory-providing organization, and transmitting a request to a directory server for a directory. The method includes receiving data defining a user interface including directory, local advertisement, and contact options, and upon receiving an indication from a user selecting the local advertisements, displaying a plurality of advertisements on the display of the user device, the advertisements including one or more redeemable incentive offers from a business local to the directory-providing organization. The method includes, upon receiving an indication from the user selecting the directory, displaying directory information on the display, the directory information including facility hours and policies, and, upon receiving a selection of the contact option, causing the mobile device to initiate contact with the directory-providing organization.

### TECHNICAL FIELD

The present application relates generally to hotel directory generation and distribution. In particular, the present application relates to a directory delivery and management system.

### BACKGROUND

Directories are printed, bound booklets typically available at a particular location, and used to describe resources available in that area. For example, a hotel directory can be placed in a guest room, and can describe the hotel facilities. Such a hotel directory can include a map of the hotel, a description of the facilities available at the hotel (e.g., exercise facilities, restaurants, conference rooms, shops, etc.) and their hours of operation. A hotel directory will also generally include policies associated with the hotel, such as the check-in and check-out times, pet policies, service hours, and other information describing the hotel.

In some cases, directories can include printed advertisements from local businesses. Those local businesses may opt to pay a fee to be included in the directory, and may include some type of incentive printed in the directory. For example, hotel guests may be able to present a room key at a local restaurant to receive a discount on a meal, or other incentives.

Existing directories are convenient in that they are easily accessed by guests or visitors of a directory provider but are not accessible by non-guests or non-visitors. However, such directories have drawbacks as well. For example, printed directories can be out of date. For example, since hotel directories are often printed annually, any changes to hotel policies would not be reflected in the hotel directory until the next print cycle, which could be months away. If, on the other hand, a hotel opts to re-print its directory, then each policy change would require a reprint of the directory.

Furthermore, hotel guests often wish to take the print copy of a hotel directory with them when visiting local businesses, for various reasons. For example, the hotel directory may include an address of a local business or map, or may include redeemable coupons or offers printed in it. In these circumstances, a hotel guest must take all or part of the hotel directory to be able to redeem the coupon or offer included in the directory.

Furthermore, hotel directories are often limited in terms of the types of information that they provide. For example, detailed directions to various locations of interest or local restaurants are typically not provided to limit the size of such directories.

Beyond hotels, similar drawbacks exist with respect to printed directories or access-controlled directories associated with other directory providers' locations. For example, mall directories are often large display stations, and have limited portability. Airport directories are also often difficult to use, large display station type directories. These types of directories are limited in their usefulness when not in the immediate vicinity of the directory, and can be difficult to update.

Accordingly, although convenient, existing printed directories have limitations, and improvements are desirable.

### SUMMARY

In accordance with the following disclosure, the above and other issues are addressed by the following:

In a first aspect, a method of delivering directory services to a user device having a display includes receiving an image of an identification code associated with a directory-providing organization, the identification code issued by the directory-providing organization, and transmitting a request to a directory server for a hotel directory. The method includes receiving data defining a user interface including directory, local advertisement, and contact options, and, upon receiving an indication from a user selecting the local advertisements, displaying a plurality of advertisements on the display of the user device, the advertisements including one or more redeemable incentive offers from a business local to the directory-providing organization. The method further includes, upon receiving an indication from the user selecting the directory, displaying directory information on the display, the directory information including facility hours and policies. The method also includes, upon receiving a selection of the contact option, causing the mobile device to initiate contact with the directory-providing organization.

In a second aspect, a directory application program executable on a mobile device having a display is disclosed that includes a menu user interface received at the mobile device in response to receipt at a directory server of an identifier associated with a directory-providing organization, the first user interface including directory, local advertisement, and contact options. The directory application program includes a directory component configured to present on the display, in response to user selection of the directory option, directory information including facility hours and policies. The program further includes a local advertisement component configured to present on the display, in response to user selection of the local advertisement option, one or more redeemable incentive offers from a business local to the directory-providing organization, and a contact component configured to, in response to user selection of the contact option, cause the mobile device to initiate contact with the directory-providing organization.

In a third aspect, a system for distributing directories to a plurality of users at a plurality of different directory-providing organizations is disclosed. The system includes a directory database including a plurality of directories associated with a corresponding plurality of different directory-providing organizations, the directories each including facility hours and policies, as well as contact information associated with each of the plurality of different directory-providing organizations and a plurality of advertisements associated with each directory, the plurality of advertisements including one or more redeemable incentive offers from a business local to the directory-providing organization. The system further includes a directory server hosting the directory database and configured to generate a plurality of web portals associated with the plurality of different directory-providing organizations, the web portal for each corresponding hotel including a directory associated with the corresponding directory-providing organization, contact information associated with the corresponding directory-providing organization, and a plurality of advertisements associated with the corresponding directory-providing organization.

### BRIEF DESCRIPTION OF THE DRAWINGS

FIG. 1 is a schematic view of a system for distributing directories, according to an example embodiment of the present disclosure;

FIG. 2 is a logical diagram of a directory database as may be used by a directory server illustrated in FIG. 1;

FIG. 3 is an example schematic diagram of an electronic computing device with which aspects of the present disclosure can be implemented;

FIG. 4 is a flowchart of a method of delivering directory services from the perspective of a directory-providing organization, according to an example embodiment;

FIG. 5 is a flowchart illustrating a portion of a method of delivering directory services performed by a user device and/or directory server, according to an example embodiment;

FIG. 6 is a flowchart illustrating a further portion of the method of delivering directory services of FIG. 5;

FIG. 7 is a flowchart illustrating a further portion of the method of delivering directory services of FIG. 5;

FIG. 8 is a schematic illustration of an example menu user interface of a portal generated by a directory server and used as part of an application program for delivery of directory services to a user, according to an embodiment of the present disclosure;

FIG. 9 is a schematic illustration of an example incentive user interface of a portal generated by a directory server, according to a possible embodiment;

FIG. 10 is a schematic illustration of an example mapping user interface of a portal generated by a directory server, according to a possible embodiment; and

FIG. 11 is a schematic illustration of an example directory user interface of a portal generated by a directory server, according to a possible embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for delivering directory services in a continually up-to-date manner that allows guests of directory-providing organizations to receive and view various features of a hotel directory in locations beyond the room in which that user is staying. The methods and systems described herein are intended to replace and/or supplement existing directories by allowing users to view additional information associated with the directory-providing organization and surrounding businesses, and extending the functionality of such existing directories by allowing for redeemable product incentives, enabling guests to contact the directory-providing organization, and presenting features analogous to those of a print directory in a continually up-to-date format. This ensures that the guest will have up to date information, while reducing requirements of reprinting directories each time a policy changes, a local business changes or goes out of business, or other alteration that would need to be reflected in the directory.

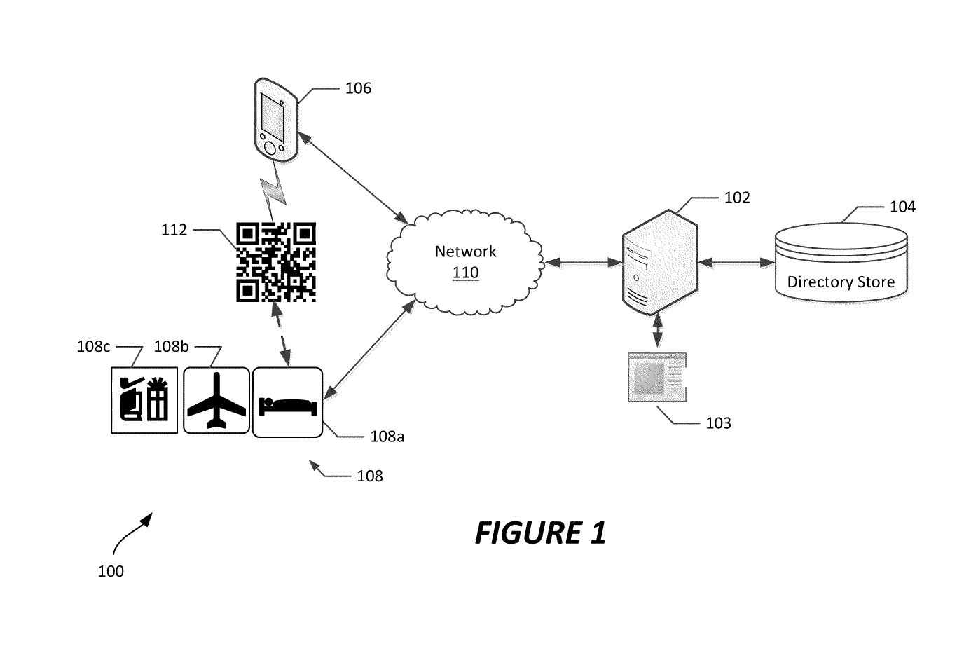

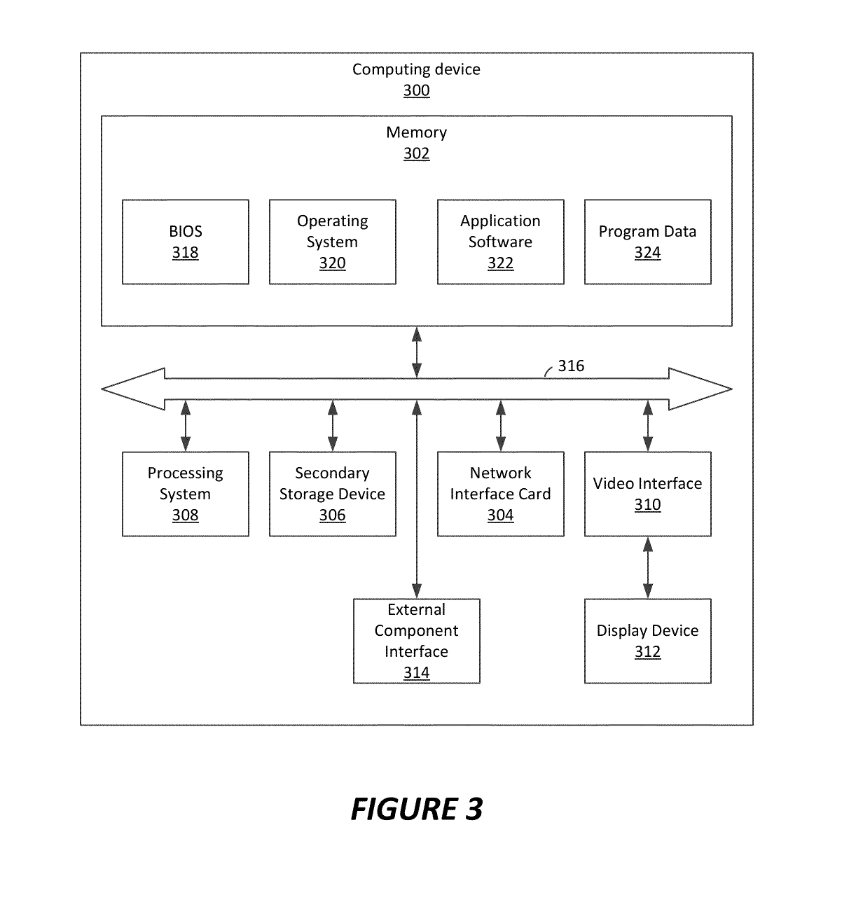

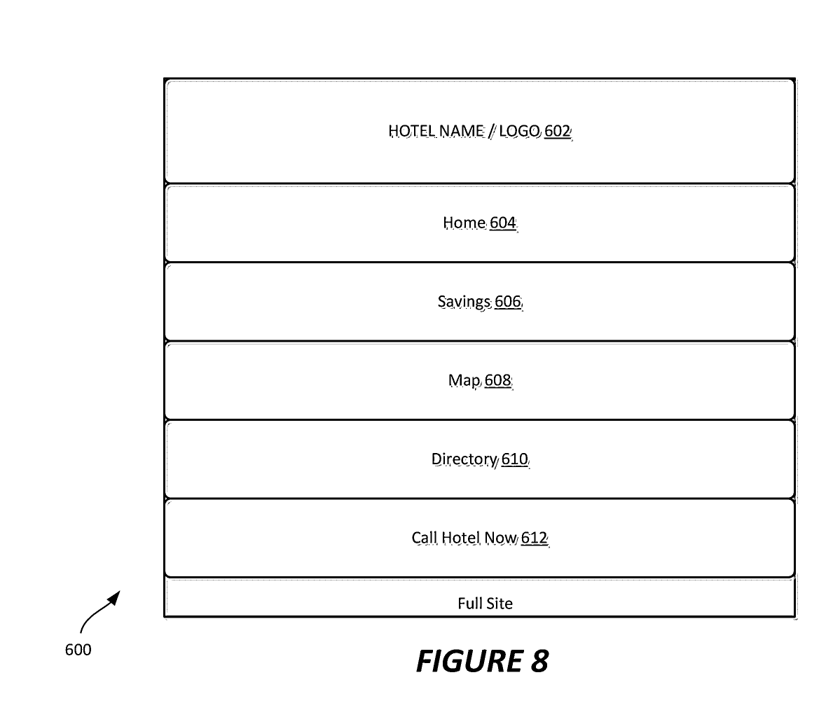

Referring to FIG. 1, a schematic view of a system 100 for distributing directories is shown, according to an example embodiment of the present disclosure. The system 100 includes a directory server 102 hosting a directory database 104. The directory server 102 can be any of a variety of computing systems, such as the general-purpose computing system described below in connection with FIG. 3; in some embodiments, the directory server 102 includes two or more such computing systems, for example a database server and a separate web interface or portal server. Other arrangements are possible as well. The directory server 102 hosts a portal 103 useable to access directory data stored in the directory database 104. The portal 103 can take a variety of forms; one example of such a portal is described below in connection with FIGS. 8-11.

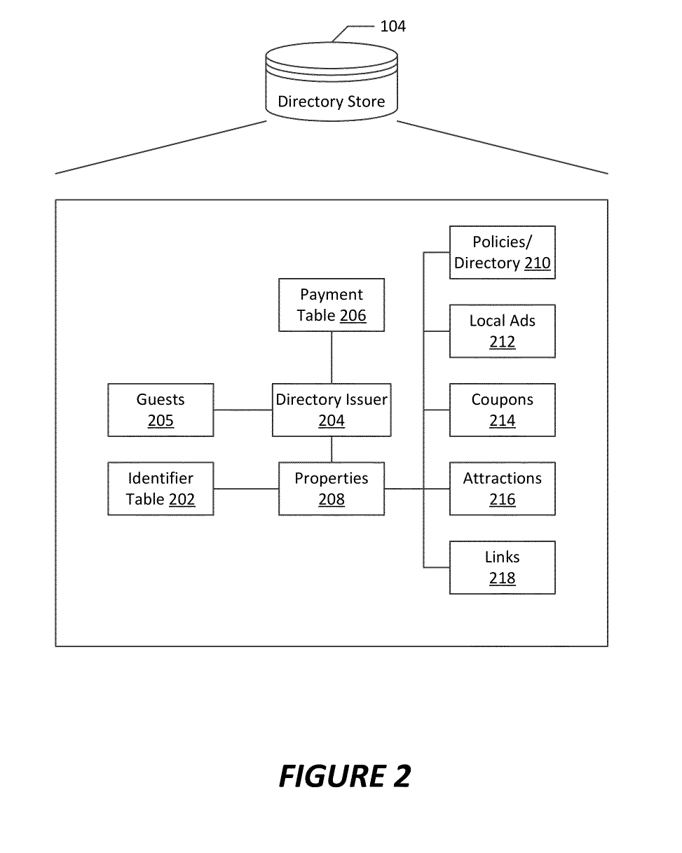

The directory database 104 stores directory information associated with a plurality of different directory-providing organizations, such as hotel chains and hotel properties, as well as malls, airports, or other multi-tenant businesses. As is recognized in the present disclosure, each directory-providing organization may have a common set of policies, but each property associated with that organization may have different facilities, or be associated with different local businesses that the specific location may recommend. Accordingly, a directory will reflect a combination of organization-specific and location-specific data and policies. An example of the various types of data that can be included in a directory distributed according to the principles of the present disclosure is illustrated in FIG. 2, which shows an example layout of a directory database 104.

In the embodiment shown, a user device 106 and a directory-providing organization 108 are communicatively connected to the directory server 102 by a network 110, such as the Internet. The user device 106 can be any of a variety of types of user devices, such as a laptop, smartphone, tablet, or other type of mobile device having a display and a browser installed thereon. The user device 106 is generally a mobile computing device, and therefore can be as described in FIG. 3 below, as well.

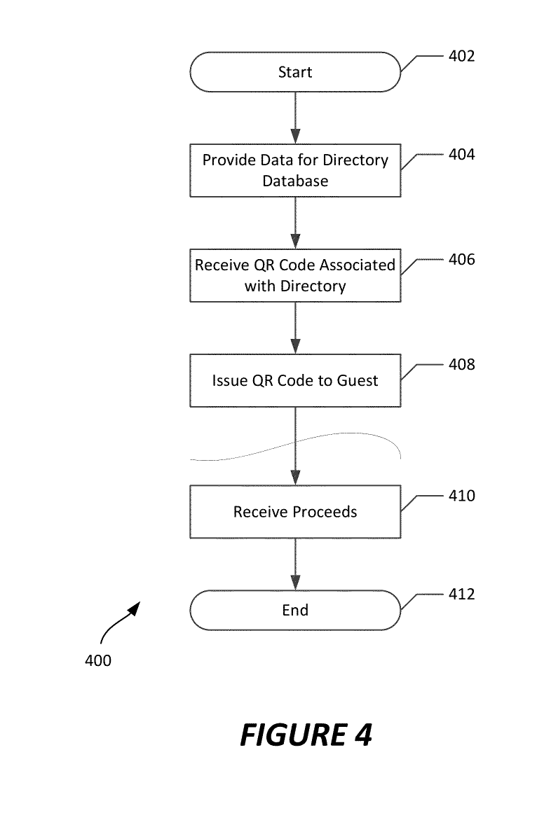

The directory-providing organizations, depicted generally as organizations 108, can include, for example, hotels 108a, malls 108b, or airports 108c, or any of a variety of other types of multi-tenant or multi-guest establishments at which a directory is provided. In the context of the present disclosure, these can include, for example, resorts, motels, extended stay establishments, theme parks, airports, train stations, or other analogous facilities. In the embodiment shown, the organization 108 will issue an identification code 112 to the guest/user, to be captured by the user device 106. In some embodiments, the identification code 112 can be a two-dimensional bar code, such as the QR code shown, which uniquely identifies the location associated therewith. In some embodiments, for example in the context of hotel services, the identification code 112 can be presented to the user/guest at a time of arrival or check-in, such as by having such a code printed on a sleeve containing a room key, or on a card inserted into that sleeve, or printed on the room key itself. A guest can then capture the identification code 112, for example by taking a picture of the identification code 112, which causes the user device 106 to be redirected, via a browser window, to a directory portal. Operation of the directory portal can be as described below in connection with FIGS. 4-11.

Referring to FIG. 2, an example layout of a directory database 104 is shown that can be used by the directory server to control distribution of directories to users of a particular directory-providing organization's facilities. In the example embodiment shown, the directory database includes a plurality of tables configured to store directory, organization, and guest data. For example, the directory database 104 in the embodiment shown includes an identifier table 202, an organization table 204, a guests table 205, a payment table 206, and a properties table 208. The identifier table 202 includes a list of identifiers used by the various hotels and hotel properties, which represent unique identifiers by which the hotels are associated with directories. In particular, when an identifier is received from a user/guest, the identifier table 202, and associated links to the organizations table 204 and properties table 208, associates the identifier with a corresponding organization and property to find the appropriate directory that is linked to that identifier.

The organizations table 204 includes a list of organizations (e.g., hotels, malls, airports, etc.) that use the directory database 104 and associated directory server 102, with which payments, properties, and guests are associated. The guests table 205 stores a listing of current guests or visitors who have access to a directory, for example those who have opted to pay for an online directory. The payment table 206 stores information regarding payments made by the guests, and confirms that payments are associated with particular properties in the properties table 208. Through the interrelationships among these tables, the database 104 can be used to determine aspects of the overall system such as (1) what guests or visitors are currently at a particular property, (2) what guests at that property have paid for access to an online directory, and (3) what identifier is associated with each property and/or organization. This set of tables therefore allows a consumer of database data to determine whether a particular user/guest should be allowed access to directory data in the directory database 104.

Associated with the properties table 208, the directory database 104 also includes a directory table 210, a local advertisements table 212, an incentives table 214, an attractions table 216, and a links table 218. These tables 210-218 correspond to data available via a portal presenting a directory to a user, accessible based on the data in tables 202-208.

The directory table 210 stores directory data associated with each particular organization identified in the organizations table 204 and each property in the properties table 208. The directory table 210 can include, for example, facility information, policies, address and contact information, hours of various facilities, hotel maps, and other information describing the organization that may be used by a guest.

The local advertisements table 212 stores one or more advertisements for goods/services available from local business in the area of the organization's facilities. The entries in the local advertisements table 212 therefore are also each associated with a particular organization and property, since each property may have its own set of associated local advertisements. Similarly, the incentives table 214 stores data associated with various types of incentives issued by the organization or surrounding businesses, such as coupons for meal discounts, or other incentives. In some such embodiments, the incentives issued can be one-time incentives for each guest, or can be repeatedly available to that user/guest.

The attractions table 216 stores a listing and details regarding attractions local to a particular property, as associated with the organizations and properties tables 204, 208, respectively. The attractions table 216 generally describes places of general interest near each property, such as churches, museums, stores, tourist attractions, etc. A links table 218 includes data associated with various links of interest, such as may be associated with a local government, weather, maps, or other types of local information sources.

The directory database 104, in the embodiment shown, is configured as a relational database; however, in alternative embodiments, other arrangements of data can be used as well. For example, a flat file database or other type of construct could be used; additionally, a cloud storage mechanism could be used for storing the directory database and performing one or more of the operations of the database server 102 as well.

Referring now to FIG. 3, a schematic illustration of an example computing system in which aspects of the present disclosure can be implemented. The computing system 300 can represent, for example, a native computing system within which one or more of computing or mobile systems 102, 106 could be implemented.

In the example of FIG. 3, the computing device 300 includes a memory 302, a processing system 304, a secondary storage device 306, a network interface card 308, a video interface 310, a display unit 312, an external component interface 314, and a communication medium 316. The memory 302 includes one or more computer storage media capable of storing data and/or instructions. In different embodiments, the memory 302 is implemented in different ways. For example, the memory 302 can be implemented using various types of computer storage media.

The processing system 304 includes one or more processing units. A processing unit is a physical device or article of manufacture comprising one or more integrated circuits that selectively execute software instructions. In various embodiments, the processing system 304 is implemented in various ways. For example, the processing system 304 can be implemented as one or more processing cores. In another example, the processing system 304 can include one or more separate microprocessors. In yet another example embodiment, the processing system 304 can include an application-specific integrated circuit (ASIC) that provides specific functionality. In yet another example, the processing system 304 provides specific functionality by using an ASIC and by executing computer-executable instructions.

The secondary storage device 306 includes one or more computer storage media. The secondary storage device 306 stores data and software instructions not directly accessible by the processing system 304. In other words, the processing system 304 performs an I/O operation to retrieve data and/or software instructions from the secondary storage device 306. In various embodiments, the secondary storage device 306 includes various types of computer storage media. For example, the secondary storage device 306 can include one or more magnetic disks, magnetic tape drives, optical discs, solid state memory devices, and/or other types of computer storage media.

The network interface card 308 enables the computing device 300 to send data to and receive data from a communication network. In different embodiments, the network interface card 308 is implemented in different ways. For example, the network interface card 308 can be implemented as an Ethernet interface, a token-ring network interface, a fiber optic network interface, a wireless network interface (e.g., WiFi, WiMax, etc.), or another type of network interface.

The video interface 310 enables the computing device 300 to output video information to the display unit 312. The display unit 312 can be various types of devices for displaying video information, such as a cathode-ray tube display, an LCD display panel, a plasma screen display panel, a touch-sensitive display panel, an LED screen, or a projector. The video interface 310 can communicate with the display unit 312 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 314 enables the computing device 300 to communicate with external devices. For example, the external component interface 314 can be a USB interface, a FireWire interface, a serial port interface, a parallel port interface, a PS/2 interface, and/or another type of interface that enables the computing device 300 to communicate with external devices. In various embodiments, the external component interface 314 enables the computing device 300 to communicate with various external components, such as external storage devices, input devices, speakers, modems, media player docks, other computing devices, scanners, digital cameras, and fingerprint readers.

The communications medium 316 facilitates communication among the hardware components of the computing device 300. In the example of FIG. 3, the communications medium 316 facilitates communication among the memory 302, the processing system 304, the secondary storage device 306, the network interface card 308, the video interface 310, and the external component interface 314. The communications medium 316 can be implemented in various ways. For example, the communications medium 316 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 302 stores various types of data and/or software instructions. For instance, in the example of FIG. 3, the memory 302 stores a Basic Input/Output System (BIOS) 318 and an operating system 320. The BIOS 318 includes a set of computer-executable instructions that, when executed by the processing system 304, cause the computing device 300 to boot up. The operating system 320 includes a set of computer-executable instructions that, when executed by the processing system 304, cause the computing device 300 to provide an operating system that coordinates the activities and sharing of resources of the computing device 300. Furthermore, the memory 302 stores application software 322. The application software 322 includes computer-executable instructions, that when executed by the processing system 304, cause the computing device 300 to provide one or more applications. The memory 302 also stores program data 324. The program data 324 is data used by programs that execute on the computing device 300.

Although particular features are discussed herein as included within an electronic computing device 300, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Referring now to FIGS. 4-11, example methods and associated user interfaces are illustrated that describe delivery of directory services to a user device are shown. The methods and user interfaces described herein represent example types of operations that can be presented using a portal-type arrangement in which a dedicated, limited access website can be presented to a user device; in alternative embodiments, other arrangements, such as a self-contained installable application deliverable to a user device, could be used as well.

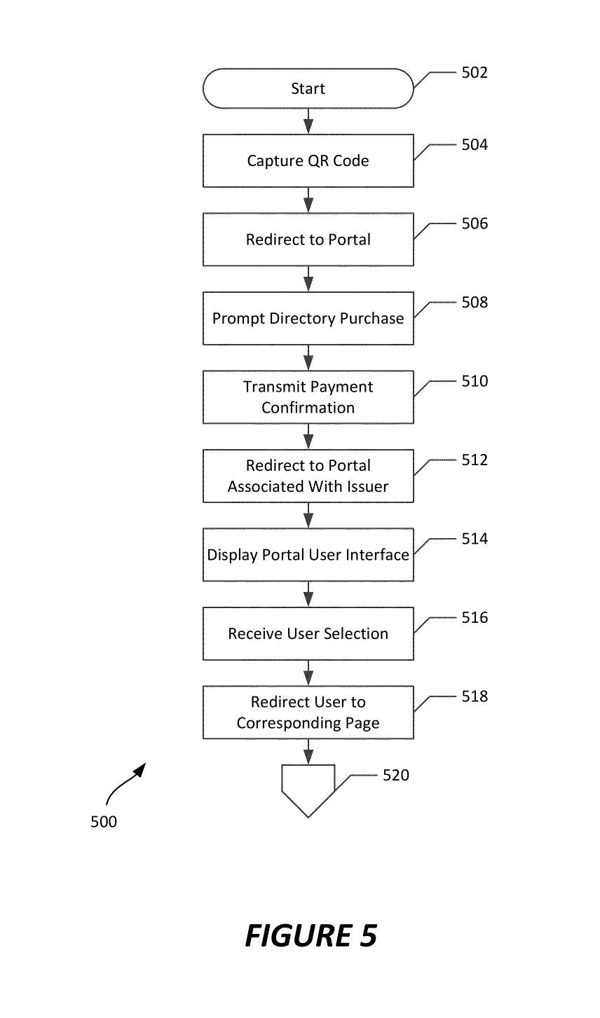

In particular, in the present disclosure, FIGS. 4-7 illustrate methods of delivering directory services to a user device, with FIG. 4 illustrating operations of an organization, and FIGS. 5-7 illustrating operations of a mobile device and/or directory server. FIGS. 8-11 illustrate example user interfaces that can be used in connection with these methods to accomplish delivery of directory services to a guest or visitor of a directory-providing organization.

Referring now to FIG. 4, a flowchart of a method 400 of delivering directory services is shown, according to an example embodiment of the present disclosure. The method 400 is generally performed by a facility for each guest or user. The method 400 is generally instantiated at a start operation 402, for example upon check-in or arrival of a guest at the facility.

As an initial operation, the organization or facility will provide data to the database server 102, for example directory information, as well as advertisement, incentives, contact information, attraction information, and other information to be accessible from an online directory service (step 404). This can include, for example, data useable to populate tables 210-218 of FIG. 2. The organization will then receive an assigned two-dimensional code, such as a QR code, to issue to guests who wish to access online directory services (step 406). Following receipt of that code, for each guest who checks in to the location, for example the front desk or other personnel at the hotel can issue the guest a copy of the QR code, for example alongside his/her room key (step 408). Alternatively, the code can be present in the room of the guest, for access via his/her mobile device. In the case of a mall or airport, the QR code or other code can be presented on a physical directory, such as at a kiosk. Other QR code distribution methods are possible as well, resulting in delivery of a QR code or other identifier to guests or visitors.

Following issuance of the QR code, the organization's responsibility with respect to delivery of a directory effectively ends; rather, the guest will interact with the directory server 102 directly. In example cases where the guest will pay some nominal fee (e.g., $1) for accessing the directory, a portion of that fee may be received by the organization for agreeing to provide the service (step 410). The organization's involvement is effectively ended following receipt of that payment, noted at end operation 412.

It is noted that, at various times, an organization or facility may wish to update information associated with that organization, such as contact information, facility hours, recommendations of associated businesses, or general announcements associated with that organization or facility. In such cases, the staff may elect to provide data to the database server, via step 404, periodically, either by accessing a maintenance area in the portal 103, or by providing such data to an administrator of the directory database 102 for updating of the database 104. In such cases, updates are reflected in subsequent data accesses by guest/users of the directory server 102, thereby keeping directory information up-to-date, for example even during a guest's stay at a particular hotel or visit to a mall or airport, without requiring replacement of a print directory.

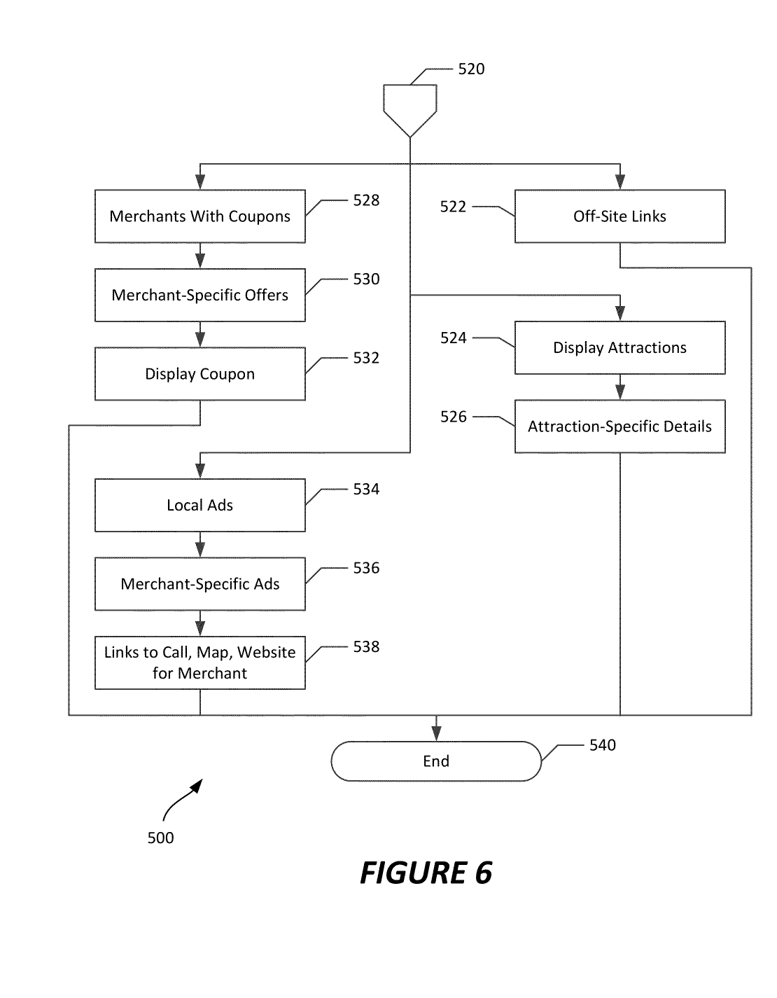

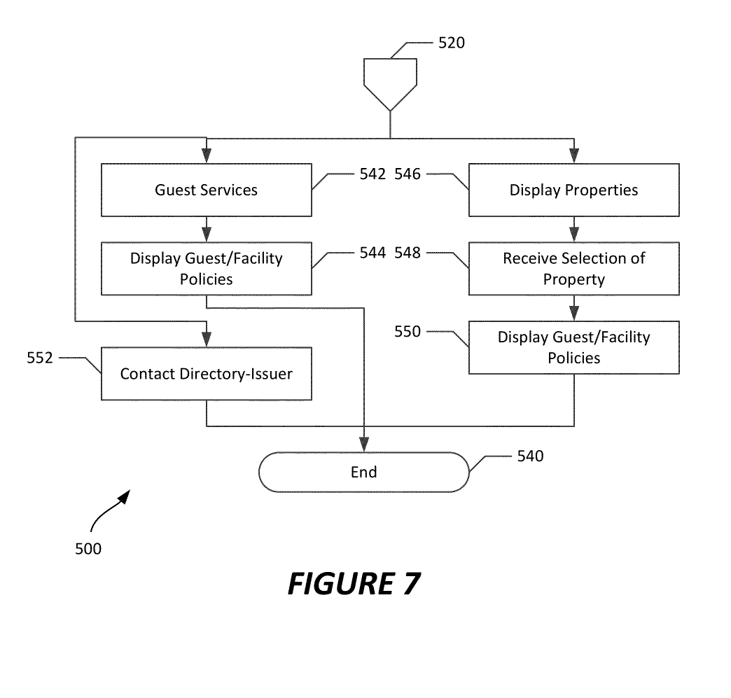

Referring now to FIG. 5-7, example interactions between a user device, such as device 106, and the directory server 102, are shown. In particular, these figures show an overall method 500 for delivering directory information to a guest or visitor on his/her mobile device. FIG. 5 illustrates a portion of this process leading to access of directory information, while FIGS. 6-7 illustrate process flows in the event the guest/user accesses different options in a portal made accessible by the directory server.

As illustrated in FIG. 5, the method 500 is instantiated at a start operation 502, which can correspond, for example, to the guest/user arriving at a location of an organization's facilities, and receiving an identifier of the organization or facility (e.g., a QR code or other identifier), as from step 408 of FIG. 4, above (step 504). The user device 106 is then redirected, for example via a mobile browser, to display a portal, such as portal 103 (step 506).

In some embodiments, at the portal, the user is prompted to purchase access to a directory, for a nominal fee (step 508). In such embodiments, the user can initiate payment to the directory server 106, for example via a credit card, PayPal, or other type of transaction (step 510).

Following access of the portal and optionally following payment, the user is redirected to a portal 103 that is associated with the organization, and preferably associated with the location at which they are associated (step 512). The portal is displayed via a display on the user device 106 (step 514), and presents a number of options to a user for selection. Example selections are illustrated in the menu user interface 600 illustrated in FIG. 8, described below.

Following display of a portal, and in particular a menu user interface, a user selection is received at the user device 106, and routed to the directory server 106 (step 516). The selection can be, for example, an indication of one of a variety of categories of information that the user wishes to view. For example, this can include a directory, advertisements, coupons or other incentives, points of interest, off-site links to websites, maps, weather, or governmental information, contact information associated with the organization location, or other information typically included in a directory. The user is then redirected to a corresponding page to view that information requested (step 518).

FIGS. 6-7 illustrated continued versions of the process 500, via off-page reference 520, to illustrate operation of a portal based on the various selections possible in the menu interface. FIG. 6, for example, illustrates navigation to off-site links information, attractions information, coupon information, and local advertisements information. This information corresponds, for example to the information stored in the corresponding tables of the directory database 104 that are affiliated or linked to a particular location, as described above in connection with FIG. 2.

In the embodiment shown, an off-site links option 522 will display various off-site links, and allow a user of a mobile device to navigate to those off-site links. These can include local information, such as weather, government, event, mapping, or other information that may be of interest to guests or visitors of the organization. The user/guest can then visit each of those off-site links to view data as desired.

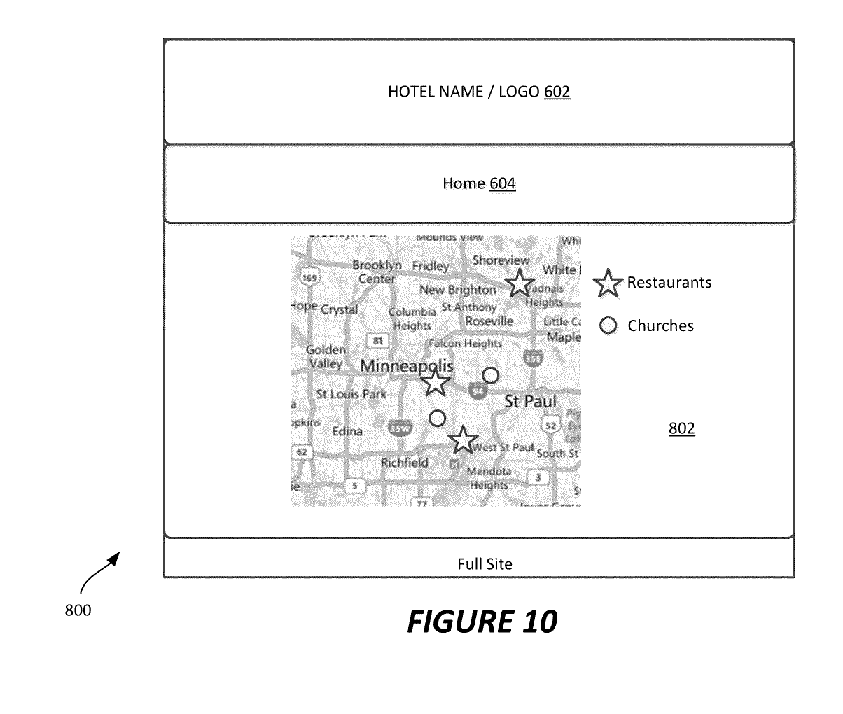

An attractions option 524 will display a set of organization-designated local attractions that may be of interest to guests. Such attractions may involve amusement parks, churches, or other locations of interest. The user may select an attraction on the mobile device, and additional details regarding that attraction (e.g., hours of operation, fees, etc.) can be displayed (step 526). In addition, a map of a variety of different locations of interest in the area of the hotel can be shown in a user interface. Furthermore, direct contact information, such as a phone contact prompt, or email link, can be included as well. An example of such a user interface is illustrated in FIG. 10, below, as applied to hotel directory delivery.

A coupons option 528 allows for display of a plurality of coupons for goods and/or services made available to guests or visitors. The user may select one or more merchants displayed in an original screen, to view merchant specific coupons (step 530). The user can then select a specific coupon or incentive for display (step 532).

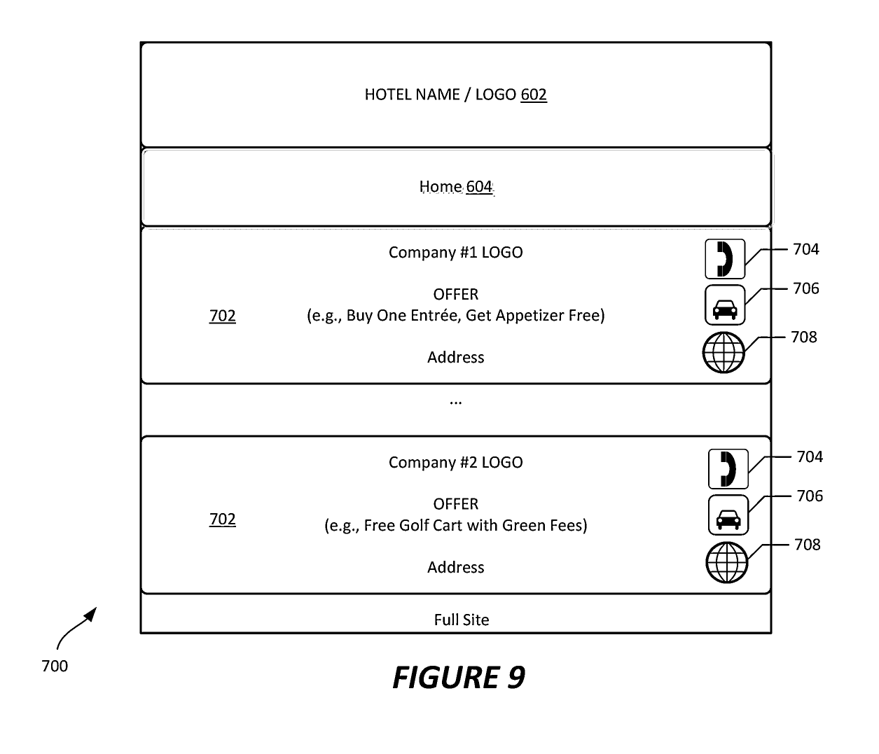

In alternative embodiments, coupons and other incentives can be displayed in line, depending on the number and size of the coupons to be displayed. Similarly, contact information for the various merchants can be provided on or with those coupons, as illustrated in the example of FIG. 9 showing hotel directory delivery, below.

Similar to the coupons option, a local advertisements option 534 allows display of a list of merchants who have advertisements for display. A user may select to display advertisements associated with a particular merchant (step 536), causing display of a subset of advertisements. Each such advertisements can include a plurality of links, for example to that merchant's website, to cause a call to be instantiated to that merchant, or to a map illustrating the location of the merchant. An analogous example of such a user interface in the context of a hotel directory delivery is illustrated in FIG. 9, below.

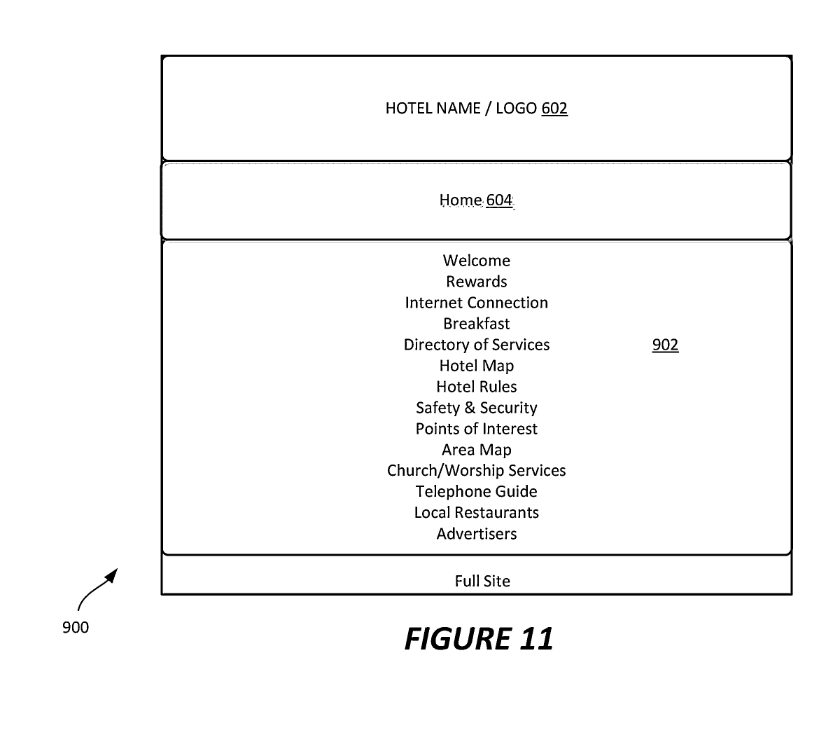

FIG. 7 illustrates additional options selectable from the menu user interface, including information about guest services, hotel properties, and contact information associated with the hotel. A guest services option 542 allows a user to view various guest services available at a particular organization's location. The user can then select to display various guest and/or facility policies associated with the location (step 544), analogous to the way an existing directory would be displayed. This can be in the form of a collection of hyperlinks to different pages of a directory, or a single scrollable document. An example of such a user interface is illustrated in FIG. 11, below; however, other embodiments are possible as well.

A properties option 546 allows a user to view a particular set of properties associated with an organization, such as specific location of a hotel chain or mall, or other hotels in a chain of hotels associated with the hotel at which the user may be staying. Upon user selection of a particular location associated with the organization (step 548), the user can be presented with information and/or facility policies associated with that different location (step 550).

A contact option 552 is also available to the user, and allows the user to directly contact the organization at the associated location, for example by email or telephone, to ask questions of a front desk, concierge, information desk, etc. This allows the user to have direct access to ask questions regarding restaurant suggestions, reservations, policies, or other issues that may arise during the course of the user's stay or visit.

It is noted that the methods of FIG. 4-7 are generally described as open-ended, in that a user who has access to a particular directory following payment may have continuing access to the directory, even after that user's stay or visit has ended. However, in some alternative embodiments, access rights to some or all of this information may expire after the user is no longer a guest or visitor of the organization. For example, the user may still be able to access information about a hotel chain's properties, but may lose access to incentives that are available only to hotel guests, or may lose access to other information, such as Wi-Fi passwords, or other types of information only relevant to current guests.

Referring now to FIGS. 8-11, a set of example user interfaces are shown that can be included in a portal 103 available from a directory server 102 are shown. The user interfaces of FIGS. 8-11 represent only some of the possible user interface arrangements that are available; accordingly, these user interfaces are intended as exemplary, rather than limiting. In particular, it is noted that the example user interfaces of FIGS. 8-11 represent usage in the context of a hotel providing hotel directory services to a guest; however, as noted above, the present disclosure is not intended to be so limited, but rather encompasses uses in other circumstances, such as at airports, malls, resorts, or other events or locations where directory services are provided to a guest and/or visitor.

In the example of FIG. 8 shown, a menu interface 600 is illustrated, which provides access to various information available through the portal 103. The menu interface includes a title bar 602, which illustrates and confirms the specific hotel with which the user/guest is associated, and for which he/she is receiving directory information. The user interface 600 also includes a plurality of selectable options, for viewing data associated with a hotel location. A home option 604 causes reload or presentation of the menu user interface 600. A savings option 606 causes display of a local advertisements or coupons display, such as is illustrated in FIG. 9, below. A map option 608 allows display on a map of one or more points of interest, as discussed above and illustrated in further detail in FIG. 10. A directory option 610 presents hotel directory information to the user, such as is illustrated in the example of FIG. 11, below.

FIG. 9 illustrates an incentive user interface 700 that can be used to display local advertisements and/or coupons or other incentives associated with that hotel for which the directory is requested. The user interface 700 includes the home option 604, and can optionally include the other navigation options 606-610 of FIG. 8 as well. In the embodiment shown, the user interface 700 also includes a plurality of incentive regions 702 that each include an incentive associated with a particular merchant local to the hotel location. The incentive regions 702 each include a description of the merchant and the incentive offered, and can also include a plurality of further information options, including a phone contact option 704, a mapping option 706, and a web option 708. The phone contact option 704 can initiate a phone call to the merchant, while the mapping option 706 can generate a map (e.g., as illustrated in FIG. 10) showing a relative location of the merchant. The web option 708 can cause routing of the user device's web browser to a website associated with that merchant. Using the various options 704-708, the user of such a directory and user interface 700 can contact any of a variety of entities, such as incentive providers, whether at the location of the directory provider or away from the directory provider.

FIG. 10 illustrates an example mapping user interface 800 that can be generated within the portal 103, and includes a mapping region 802 that can be generated to illustrate, for example, locations of area attractions in response to selection of a map option 608 as seen in FIG. 8, or a particular business or merchant, as may be triggered from the option 706 of FIG. 9, above. Other uses for the mapping user interface 800 can be included as well, such as identification of area roads, running trails, or other areas of potential interest to the hotel guest as well.

FIG. 11 illustrates an example directory user interface 900 of a portal generated by a directory server, according to a possible embodiment. The user interface 900 includes the home option 604, and can optionally include the other navigation options 606-610 of FIG. 8 as well. In the embodiment shown, the user interface 900 also includes a directory window 902 in which hotel directory information is shown. For example, general information associated with the hotel, such as facility hours and policies, can be displayed, alongside other information generally included in a hotel directory.

Referring now to FIGS. 1-11 generally, it is noted that the directory delivery and management system described herein allows for a number of advantages over existing print-based directory arrangements. For example, the methods and systems described herein allow users to view additional information associated with the directory-issuing organization and surrounding businesses, and extends the functionality of existing directories by allowing for redeemable product incentives, enabling guests and/or visitors to contact the organization and those associated local businesses directly, and presenting features analogous to those of a directory in a continually up-to-date format. This ensures that the guest or visitor will have up to date information, while reducing requirements of reprinting directories each time a policy changes, a local business changes or goes out of business, or other alteration occurs that would need to be reflected in the directory. Furthermore, the directory features described herein can be accessible by guests or visitors even away from the directory-provider's facilities, allowing for convenient reference and use that would not typically be done with existing directories, which are intended to remain at the location of the directory provider. While either at the directory provider's location or away, the users can contact any of the entities listed in the directory, such as the directory provider, or any advertisers or coupon/incentive issuers, or points of interest to the user. Additionally, access to such directories can be selectively provided on an ongoing basis, or limited to the time in which the user is staying at the hotel or resort, or visiting the mall or airport, which provides for a variety of customizable approaches for different organizations and directory providers.

The above specification, examples and data provide a complete description of the manufacture and use of the composition of the invention. Since many embodiments of the invention can be made without departing from the spirit and scope of the invention, the invention resides in the claims hereinafter appended.

1. A method of delivering hotel directory services to a user device having a display, the method comprising:
receiving an image of an identification code associated with a directory-providing organization, the identification code issued by the directory-providing organization;
transmitting a request to a directory server for a directory;
receiving data defining a user interface including directory, local advertisement, and hotel contact options;
upon receiving an indication from a user selecting the local advertisements, displaying a plurality of advertisements on the display of the user device, the advertisements including one or more redeemable incentive offers from a business local to the directory-providing organization;
upon receiving an indication from the user selecting the directory, displaying directory information on the display, the directory information including facility hours and policies associated with the directory-providing organization; and
upon receiving a selection of the contact option, causing the mobile device to initiate contact with the directory-providing organization.

2. The method of claim 1, wherein the mobile device comprises a smartphone.

3. The method of claim 1, wherein causing the mobile device to initiate contact with the directory-providing organization comprises causing the mobile device to dial a phone number contacting the directory-providing organization.

4. The method of claim 1, wherein the one or more redeemable incentive offers are non-destructively redeemable incentives.

5. The method of claim 1, further comprising, after transmitting a request to a directory server, accessing data from a portal accessible via the directory server.

6. The method of claim 1, further comprising, after transmitting the request, displaying a page including payment option information.

7. The method of claim 6, further comprising, prior to display of the user interface, transmitting payment confirmation to the directory server.

8. The method of claim 7, further comprising, at some time after receiving at the directory server the payment confirmation, periodically transmitting at least a portion of a payment to the directory-providing organization.

9. The method of claim 1, wherein, after updates are made in the directory, an indication from the user selecting the directory results in displaying updated directory information on the display.

10. The method of claim 1, wherein the user interface is accessible for a length corresponding to a length of visit of the user at the directory-providing organization.

11. The method of claim 1, wherein receiving the image of the identification code comprises capturing an image of a two-dimensional code issued to the user upon arrival at the directory-providing organization.

12. A directory application program executable on a mobile device having a display, the directory application program including:
a menu user interface received at the mobile device in response to receipt at a directory server of an identifier associated with a hotel, the first user interface including directory, local advertisement, and hotel contact options;
a directory component configured to present on the display, in response to user selection of the directory option, a hotel directory information including hotel facility hours and hotel policies;
a local advertisement component configured to present on the display, in response to user selection of the local advertisement option, one or more redeemable incentive offers from a business local to the hotel; and
a hotel contact component configured to, in response to user selection of the hotel contact option, cause the mobile device to initiate contact with the hotel.

13. The directory application program of claim 12, wherein one or more of the directory component, local advertisement component, and hotel contact component are stored at a directory server and retrieved by the mobile device in response to selection of a corresponding option in the menu user interface.

14. The directory application program of claim 12, wherein the menu user interface is received from the directory server in response to payment authorization received from the mobile device.

15. The directory application program of claim 12, wherein the menu user interface is customized for the directory-providing organization, and wherein the hotel is identified to the directory server from the mobile device based on a two dimensional graphical code captured by the mobile device.

16. The directory application program of claim 12, wherein the directory-providing organization is selected from among a group of organizations consisting of:
a hotel;
a mall;
an airport;
a resort;
an amusement park; and
a multi-tenant commercial business.

17. A system for distributing directories to a plurality of users at a plurality from different directory-providing organizations, the system comprising:
a directory database including:
a plurality of directories associated with a corresponding plurality of different directory-providing organizations, the directories each including facility hours and policies;
contact information associated with each of the plurality of different directory-providing organizations;
a plurality of advertisements associated with each directory, the plurality of advertisements including one or more redeemable incentive offers from a business local to the directory-providing organization;
a directory server hosting the directory database and configured to generate a plurality of web portals associated with the plurality of different directory-providing organizations, the web portal for each corresponding hotel including a directory associated with the corresponding directory-providing organization, contact information associated with the corresponding directory-providing organization, and a plurality of advertisements associated with the corresponding directory-providing organization.

18. The system of claim 17, wherein the directory server comprises a plurality of computing systems.

19. The system of claim 17, wherein the directory server is configured to grant access to the web portal to each of a plurality of users, the plurality of users corresponding to guests at a hotel.

20. The system of claim 19, wherein the directory database includes a plurality of identifiers each associated with a different hotel from among a plurality of different hotels, and wherein receipt of one of the plurality of identifiers from a mobile device associated with one of the plurality of users causes the directory server to identify which of the plurality of web portals to expose to the mobile device.

21. The system of claim 20, wherein the plurality of identifiers comprise QR-codes assigned to the plurality of different directory-providing organizations.
